(19) United States
(12) Patent Application Publication
(10) Pub. No.: US 2014/0186800 A1
(43) Pub. Date: Jul. 3, 2014

(54) DENTAL IMPLANT

(71) Applicant: METAL INDUSTRIES RESEARCH & DEVELOPMENT CENTRE, (US)

(72) Inventors: BO-WEI PAN, Kaohsiung (TW); TUNG-LIN TSAI, Kaohsiung (TW); YI-CHIN CHEN, Kaohsiung (TW); SHIEN-NAN KUO, Kaohsiung (TW)

(73) Assignee: METAL INDUSTRIES RESEARCH & DEVELOPMENT CENTRE, Kaohsiung (TW)

(21) Appl. No.: 13/728,719

(22) Filed: Dec. 27, 2012

(51) Int. Cl. A61C 8/00

(52) U.S. Cl. CPC A61C 8/0018
USPC 433/174

(57) ABSTRACT

The invention provides a dental implant including a neck portion, a bottom portion and a body portion. The body portion connects the neck portion and the bottom portion. The body portion has a first end, a second end and a plurality of threads. The threads are disposed between the first end and the second end. Along a long axial direction and a direction from the first end to the second end, the cusp widths of the threads gradually increase, or heights from the cusp to the root of the threads gradually decrease. Therefore, the dental implant can be used to gradually squeeze and expand the alveolar bone and meanwhile improve the density of the alveolar bone, so that the dental implant has desirable initial-stage stability after the dental implant surgery, thereby solving the micromotion phenomenon after the instant dental implant surgery, and facilitating subsequent osseointegration.

### BACKGROUND OF THE INVENTION

1. Field of the Invention

The present invention relates to a dental implant.

2. Description of the Related Art

Structure design of conventional dental implants is mainly aimed at improving the bone contact area and enhancing the firmness of the abutment connection. However, edentulous patients still need to wait more than 3 months of osseointegration before the prosthesis replacement. Patients have to live with the embarrassment of missing tooth for 3 months, which seriously affects the facial appearance and social activities of the patients.

For the edentulous condition of the patient due to tooth extraction or an accident, a dentist usually performs an instant dental implant surgery using a proper dental implant, so that the patient can have a prosthesis immediately, thereby recovering the facial appearance of the patient. However, according to the clinical result, in the instant dental implant surgery, after the dental implant is planted, apart from the osseointegration, the most required functions are initial-stage stability and the later stress scattering. The performance of the initial-stage stability has an impact on the success of the subsequent osseointegration. Briefly, the shake and rotation conditions in the initial-stage after the dental implant is planted indicate a greater failure possibility of the subsequent osseointegration. If the obvious micromotion of the planted dental implant is generated, it will prolong the process of osseointegration, and in this case, instead of the osseointegration, fiber tissue is generated around the dental implant.

Therefore, it is necessary to provide a dental implant to solve the above problems.

### SUMMARY OF THE INVENTION

The present invention provides a dental implant. The dental implant of the invention includes a neck portion, a bottom portion and a body portion. The neck portion is used to connect an abutment. The body portion connects the neck portion and the bottom portion. The body portion has a first end, a second end and a plurality of threads. The first end is connected to the bottom portion. The second end is connected to the neck portion. The threads are disposed between the first end and the second end. Along a long axial direction and a direction from the first end to the second end, cusp widths of the threads gradually increase.

The present invention further provides a dental implant. The dental implant of the invention includes a neck portion, a bottom portion and a body portion. The neck portion is used to connect an abutment. The body portion connects the neck portion and the bottom portion. The body portion has a first end, a second end and a plurality of threads. The first end is connected to the bottom portion. The second end is connected to the neck portion. The threads are disposed between the first end and the second end. Along a long axial direction and a direction from the first end to the second end, heights from the cusp to the root of the threads gradually decrease.

By using the threads with the variable cusp widths and the threads with variable height from the cusp to the root, the dental implant of the present invention can be used in the planting process to gradually squeeze and expand the alveolar bone and meanwhile improve the density of the alveolar bone, so that the dental implant has desirable initial-stage stability after the dental implant surgery, thereby solving the micromotion phenomenon after the instant dental implant surgery, and facilitating subsequent osseointegration.

### BRIEF DESCRIPTION OF THE DRAWINGS

FIG. 1 shows a schematic view of a dental implant according to the present invention; and

FIG. 2 shows a schematic partial enlarged view of a dental implant according to the present invention.

### DETAILED DESCRIPTION OF THE INVENTION

The terms “upper” and “lower” mentioned in the specification are irrelevant to the gravity. The term “upper” indicates the property of being close to an occlusal surface or an incisal end of a connected prosthesis, and the term “lower” indicates an opposite property.

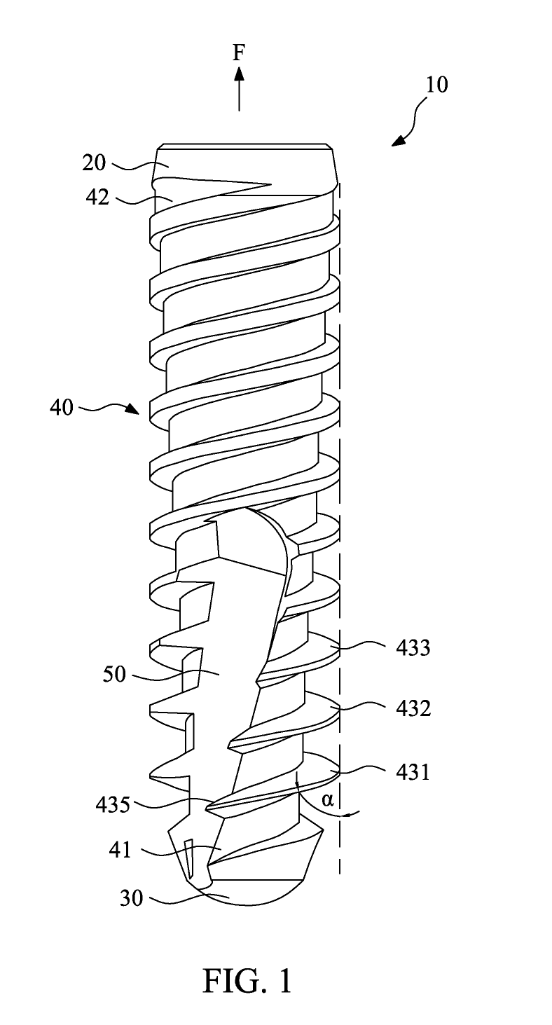

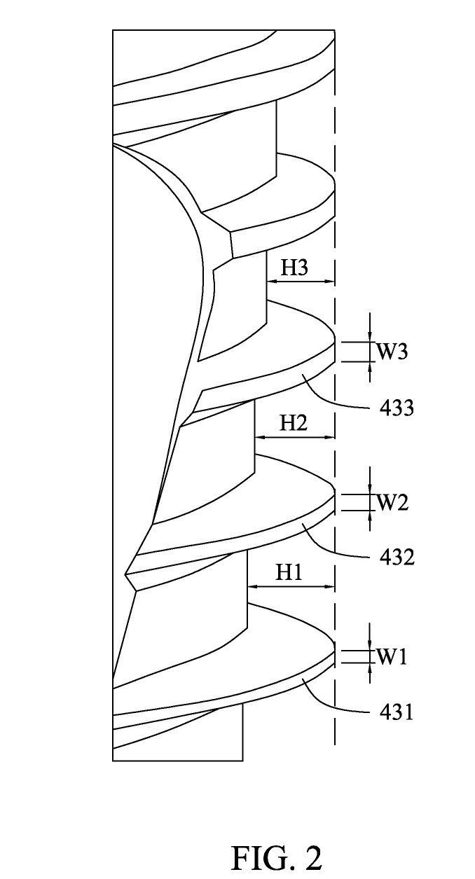

FIG. 1 shows a schematic view of a dental implant according to the present invention. FIG. 2 shows a schematic partial enlarged view of a dental implant according to the present invention. Referring to FIG. 1 and FIG. 2, a dental implant 10 of the present invention includes a neck portion 20, a bottom portion 30 and a body portion 40. The neck portion 20 is used to connect an abutment (not shown in the figure). In this embodiment, the neck portion 20 is a non-threaded structure. Preferably, the bottom portion 30 is arc-shaped so as to scatter a biting force.

The body portion 40 connects the neck portion 20 and the bottom portion 30. The body portion 40 has a first end 41, a second end 42 and a plurality of adjacent threads 431, 432 and 433. The first end 41 is connected to the bottom portion 30. The second end 42 is connected to the neck portion 20. The threads 43 are disposed between the first end 41 and the second end 42. Along a long axial direction and a direction from the first end 41 to the second end 42, the cusp widths of the threads 431, 432 and 433 gradually increase. That is, the cusp width of the first thread 431 is W1, the cusp width of the second thread 432 is W2, and the cusp width of the third thread 433 is W3. Along the direction from the first end 41 to the second end 42, the cusp width W2 is greater than the cusp width W1, and the cusp width W3 is greater than the cusp width W2.

By using the threads with the variable cusp widths, the dental implant of the present invention can be used in the planting process to gradually squeeze and expand the alveolar bone and meanwhile improve the density of the alveolar bone, so that the dental implant has desirable initial-stage stability after the dental implant surgery, thereby solving the micromotion phenomenon after the instant dental implant surgery, and facilitating subsequent osseointegration.

The dental implant 10 of the present invention further includes a cutting groove 50, which is vertically formed in the body portion 40 in a spiral manner and along the long axial direction F, extends to the bottom portion 30, and is intersected with a part of the threads 431, 432 and 433. In this embodiment, the length of the cutting groove 50 is not greater than 70% of the total length of the dental implant 10. By using the cutting groove 50, the dental implant 10 of the present invention can gradually expand the cavity of the alveolar bone during the planting process, thereby reducing the implant torsion and alleviating discomfort after the surgery.

At least one thread of the dental implant of the present invention can include a sharp cutting area, which is disposed at an edge of the cutting groove, and disposed at a side corresponding to a rotating direction of the thread. For example, the first thread 431 includes a sharp cutting area 435. The first thread 431 of the body portion 40 is a right-hand thread. According to the screw-in direction of the right-hand thread, the sharp cutting area 435 is disposed at a right edge of the cutting groove 50. During the planting process, the sharp cutting area 435 can be used to cut into the alveolar bone, so that the dental implant 10 of the present invention is easily screwed into the alveolar bone.

In this embodiment, the cusp widths of the threads of the dental implant 10 are variable, the thread, for example the section of the thread, at the first end 41 is slightly V-shaped, and as the cusp width of the thread gradually increases, the thread, for example the section of the thread, at the second end 42 is trapezoidal or rectangular, so as to improve the bone contact area. In other embodiments, the thread of the dental implant of the present invention is arc-shaped or in other shapes.

In addition, along the long axial direction F and along the direction from the first end 41 to the second end 42, the heights from the cusp to the root of the threads 431, 432, and 433 of the dental implant 10 of the present invention gradually decrease. That is, the height from the cusp to the root of the first thread 431 is H1, the height from the cusp to the root of the second thread 432 is H2, and the height from the cusp to the root of the third thread 433 is H3. Along the direction from the first end 41 to the second end 42, the height H1 is greater than the height H2, and the height H2 is greater than the height H3.

By using the threads with variable height from the cusp to the root, the dental implant of the present invention squeezes and expands the alveolar bone during the planting process, and meanwhile improve the density of the alveolar bone, so that the dental implant has desirable initial-stage stability after the dental implant surgery, thereby solving the micromotion phenomenon after the instant dental implant surgery, and facilitating subsequent osseointegration.

The height from the cusp to the root of the threads of the dental implant 10 of the present invention is variable, so that the diameter formed by the roots of the threads also gradually increase along the direction from the first end 41 to the second end 42. Therefore, relative to an outer diameter (represented by the dash line in FIG. 1) formed by the cusps of the threads, the diameter formed by the roots of the threads has an inclination angle α, and the inclination angle α is preferably 0.5 to 5 degrees.

While several embodiments of the present invention have been illustrated and described, various modifications and improvements can be made by those skilled in the art. The embodiments of the present invention are therefore described in an illustrative but not in a restrictive sense. It is intended that the present invention should not be limited to the particular forms as illustrated and that all modifications which maintain the spirit and scope of the present invention are within the scope defined in the appended claims.

What is claimed is:

1. A dental implant, comprising:
a neck portion;
a bottom portion;
a body portion, connected the neck portion and the bottom portion, the body portion having a first end, a second end and a plurality of threads, the first end connected to the bottom portion, the second end connected to the neck portion, the threads disposed between the first end and the second end, wherein along a long axial direction and a direction from the first end to the second end, cusp widths of the threads gradually increase; and
a cutting groove, vertically formed in the body portion in a spiral manner along the long axial direction and extending to the bottom portion,
wherein at least one thread comprises a sharp cutting area disposed at an edge of the cutting groove, and disposed at a side corresponding to a rotating direction of the thread,
wherein the sharp cutting area comprises a sharp portion extending into the cutting groove.

2. (canceled)

3. (canceled)

4. The dental implant according to claim 1, wherein a length of the cutting groove is not greater than 70% of a total length of the dental implant.

5. The dental implant according to claim 1, wherein a section of the thread is V-shaped, trapezoidal, rectangular or arc-shaped.

6. A dental implant, comprising:
a neck portion;
a bottom portion;
a body portion, connected the neck portion and the bottom portion, the body portion having a first end, a second end and a plurality of threads, the first end connected to the bottom portion, the second end connected to the neck portion, the threads disposed between the first end and the second end, wherein along a long axial direction and a direction from the first end to the second end, heights from a cusp to a root of the threads gradually decrease; and
a cutting groove, vertically formed in the body portion in a spiral manner along the long axial direction and extending to the bottom portion,
wherein at least one thread comprises a sharp cutting area disposed at an edge of the cutting groove, and disposed at a side corresponding to a rotating direction of the thread,
wherein the sharp cutting area comprises a sharp portion extending into the cutting groove.

7. (canceled)

8. (canceled)

9. The dental implant according to claim 6, wherein relative to an outer diameter formed by the cusps of the threads, a diameter formed by the roots of the threads has an inclination angle.

10. The dental implant according to claim 9, wherein the inclination angle is 0.5 to 5 degrees.
